(19) United States
(12) Patent Application Publication
(10) Pub. No.: US 2023/0095195 A1
(43) Pub. Date: Mar. 30, 2023

(54) Test Piece for Testing a Washing Performance of an Industrial Washing Machine

(71) Applicant: ZF Friedrichshafen AG, Friedrichshafen (DE)

(72) Inventors: Philip Schiele, Saarbrücken (DE); Anton Igel, Saarbruecken (DE); Marcel Boncourt, Püttlingen (DE); Daniel Krier, Schwalbach (DE)

(21) Appl. No.: 17/954,424

(22) Filed: Sep. 28, 2022

(30) Foreign Application Priority Data
Sep. 29, 2021 (DE) 102021210880.6

(51) Int. Cl. G01M 99/00

(52) U.S. Cl. CPC G01M 99/005

(57) ABSTRACT

A test piece (10) for testing a washing performance of an industrial washing machine includes a first side element (11) with at least one first plane surface (21) and also a second side element (12) with at least one second plane surface (22). The first side element (11) is connectable to the second side element (12) so that the first plane surface (21) faces the second plane surface (22). The first plane surface (21) includes first bores (31), and the second plane surface (22) includes second bores (32). When the first side element (11) is connected to the second side element (12), the first bores (31) are arranged in axial extension of the second bores (32), and a plastically deformable foil (40) is disposed between the first plane surface (21) and the second plane surface (22).

### CROSS-REFERENCE TO RELATED APPLICATION

The present application is related and claims priority to 102021210880.6 filed in the German Patent Office on Sep. 29, 2021, which is incorporated by reference in its entirety for all purposes.

### FIELD OF THE INVENTION

The invention relates generally to a test piece for testing a washing performance of an industrial washing machine.

### BACKGROUND

In the prior art, industrial washing installations are known that often include an intake station, an industrial washing machine, where appropriate a drying station, and also a discharge station. Workpieces to be washed are taken in, for example via the intake station, then fed via a conveyor belt to the washing machine and washed there. The washed workpieces are conveyed back out of the washing machine via a further conveyor belt and, where appropriate, conveyed to a drying station and dried there by hot air. Finally, the workpieces are conveyed to the discharge station and taken out there.

An industrial washing machine that enables the washing of workpieces in a continuous process of such a type is known from U.S. Pat. No. 4,327,756 A, for instance.

An industrial washing machine with at least one washing chamber for washing workpieces is known from DE 0000696 15 391 T2, the washing chamber being arranged between a first conveyor and a second conveyor. An injection member injects washing liquid into the washing chamber.

However, the known industrial washing machines are burdened by the disadvantage that there is as yet no reliable way to examine the cleaning performance of the industrial washing machines in operation reliably and objectively.

### SUMMARY OF THE INVENTION

Example aspects of the present invention provide an improved test piece for testing a washing performance of an industrial washing machine.

Example aspects of the invention relate to a test piece for testing a washing performance of an industrial washing machine, including a first side element with at least one first plane surface and also a second side element with at least one second plane surface. The first side element is capable of being connected to the second side element so that the first plane surface abuts the second plane surface. The first plane surface exhibits first bores, and the second plane surface exhibits second bores. The test piece according to example aspects of the invention is distinguished in that in a state where the first side element is connected to the second side element the first bores are arranged in axial extension of the second bores, and in that a plastically deformable foil has been inserted between the first plane surface and the second plane surface.

Example aspects of the invention accordingly provide a test piece that is suitable to test the washing performance of an industrial washing machine. An “industrial washing machine” in this context is understood to mean a washing machine that cleans workpieces—in particular, metallic workpieces—after an intermediate treatment step or after a final treatment step. Amongst other things, the workpieces are cleansed of adhering cutting oil or of adhering chips arising from the treatment process.

The industrial washing machine is preferably part of a washing plant that, in addition to the actual washing machine, also includes a workpiece-receiving station, a workpiece-issuing station and a workpiece-drying station, the individual stations advantageously being connected to one another by conveyor belts, so that the workpieces automatically pass through the washing plant and the washing process being carried out after the workpieces have been fed to the workpiece-receiving station. For instance, after passing through a station, the workpieces can be placed on a conveyor belt by a robot gripper and can be picked up again by another robot gripper upon reaching another station.

Particularly preferably, the washing plant includes two different industrial washing machines, of which a first washing machine is a low-pressure washing machine that cleans the workpieces at a pressure of less than ten (10) bar, and a second washing machine is a high-pressure washing machine that cleans the workpieces at a pressure of two hundred (200) bar to six hundred (600) bar. The test piece according to example aspects of the invention is suitable for testing the washing performance of, in particular, a high-pressure washing machine but, in principle, can also be used for testing the washing performance of a low-pressure washing machine. Furthermore, the washing plant preferably includes a workpiece-rinsing station, in which cleaning agent remaining on the workpieces from the washing process is rinsed off, and also a first workpiece-drying station which generates a drying action, for example by generating an underpressure or a vacuum, and also a second workpiece-drying station which generates a drying action, for example with the aid of hot air. All the stations are advantageously connected by conveyor belts or similar conveying mechanisms.

The test piece includes two side elements capable of being laid against each other, each of the side elements exhibiting a plane surface. In the connected state of the side elements, the plane surfaces abut each other, and the side elements together define the external geometry of the test piece. In the non-connected state, the test piece has correspondingly been disassembled into individual parts—that is to say, amongst other things, the at least two side elements.

Both the first plane surface and the second plane surface each exhibit a series of bores. All the bores preferably have the same diameter. The bores preferably sink into the first plane surface and the second plane surface perpendicularly in each instance.

Now, in accordance with example aspects of the invention, it is specified that in a state where the first side element is connected to the second side element the first bores are arranged in axial extension of the second bores. This accordingly means that when the first side element has been connected to the second side element the first bores and the second bores have been arranged in such a manner that in each instance a first bore is situated in axial extension of a second bore, and conversely.

Furthermore, in accordance with example aspects of the invention, it is specified that in the state where the first side element is connected to the second side element a plastically deformable foil has been inserted between the first plane surface and the second plane surface.

The test piece can then advantageously be channelled into the washing plant like a workpiece to be washed, and can pass through the entire washing process, inclusive of drying, or can be channelled selectively into the washing machine to be tested. Advantageously, the washing operation of the washing machine does not have to be interrupted for the purpose of testing the washing performance via the test piece according to example aspects of the invention. Within the scope of the washing process, the test piece is blasted in the washing machine, from nozzles of the washing machine designed for this purpose, with water jets which penetrate from an outside of the test piece into the first and the second bores and then subject the foil clamped between the first surface and the second surface to the action of water pressure. Depending upon the pressurisation and properties of the foil, by reason of the water pressure, a plastic deformation can now arise on the foil in the effective direction of the water pressure, the foil being invariably selected, in accordance with example aspects of the invention, to be adapted to the set water pressure in such a manner that a plastic deformation occurs when the actual water pressure corresponds to the water pressure desired for washing.

Consequently, the water pressure emerging from the nozzles for the purpose of washing in the washing machine can be characterised in straightforward manner. Since the water pressure is decisive for the washing performance of the washing machine, the washing performance of the washing machine can be tested correspondingly in straightforward manner.

According to another preferred example embodiment of the invention, it is specified that the foil takes the form of metallic foil. This has proved suitable, on the one hand, in that metals, even in foil form, are stable enough to withstand a water pressure of several hundred bar and, on the other hand, in that metals enable the required degree of plastic deformability.

According to a particularly preferred example embodiment of the invention, it is specified that the foil takes the form of aluminium foil. This has proved to be particularly well-suited in practical trials.

In particular, the aluminium foil is selected in such a way that the aluminium foil has a material thickness of two-tenths millimetre (0.2 mm) at a water pressure of four hundred and fifty (450) bar.

According to another preferred example embodiment of the invention, it is specified that the first bores take the form partly of first through-bores and partly of first blind bores, and that the second bores take the form partly of second through-bores and partly of second blind bores.

The first bores are preferably arranged side by side in rows. The rows are preferably arranged one above the other. Similarly, the second bores are also preferably arranged side by side in rows, the rows being arranged, here too, one above the other.

Furthermore, the first bores preferably take the form of, alternately, through-bores and blind bores, so that in each row a through-bore is invariably adjacent to two blind bores, and conversely. The second bores are advantageously arranged in the same way.

According to a particularly preferred example embodiment of the invention, it is specified that, in a state where the first side element is connected to the second side element, the first blind bores are arranged in axial extension of the second through-bores, and that, in a state where the first side element is connected to the second side element, the second blind bores are arranged in axial extension of the first through-bores. Consequently, a first through-bore is accordingly situated invariably in axial extension with a second blind bore. Similarly, each second through-bore is situated in axial extension with a first blind bore.

Hence, it is advantageously made possible that the test piece is subjected along an entire surface of the test piece—in particular, from both sides—to the water pressure from the nozzle or nozzles in the washing plant, and in the process the water pressure penetrates from outside into each of the first and second through-bores. Each of the first and second through-bores is preferably even subjected to blasting selectively, in particular for a defined length of time, for instance a half second (0.5 s). Since the first and second through-bores are invariably followed in axial extension by a first and a second blind bore, respectively, the foil inserted between the first and second surfaces has spatial clearance to deform plastically into the respective blind bore by reason of the water pressure. The plastic deformation arising is, as a rule, substantially hemispherical. After the washing process, on the basis of an evaluation of the plastic deformations of the foil and also an assignment of the deformations to a particular nozzle of the washing machine, it can then be identified whether, where appropriate, one or more nozzles of the washing machine is/are providing an unsatisfactory washing performance. A possible cause may be, for instance, a clogged nozzle or even a leaky pressure feed line.

According to another preferred example embodiment of the invention, it is specified that an external geometry of the test piece corresponds identically to an external geometry of a workpiece to be washed by the washing machine. As a result, the washing performance can be tested particularly reliably and near to the workpieces actually to be washed. In particular, the test piece can be channelled into the washing machine or washing plant like a workpiece to be washed, together with one or more workpieces to be washed.

According to a particularly preferred example embodiment of the invention, it is specified that the test piece simulates a hydraulic gearshift device of a vehicle gear mechanism. Gearshift devices of such a type are comparatively costly to clean, by reason of their large number of bores, but, in particular, all chips have to be reliably removed from the bores, in order to avoid later damage to or blockage of valves. The testing of the washing performance of a washing machine for workpieces of such a type is therefore important, in order to be able to guarantee at all times a sufficient washing performance and hence functional capability of the gearshift device.

In contrast to the bores of the hydraulic gearshift device, however, the bores of the test piece are not connected to one another in the manner of a labyrinth. For, as it turns out, this is not necessary for the purpose of testing the washing performance. Instead, the test piece simulates the gearshift device only in the external geometry of the test piece.

According to another preferred example embodiment of the invention, it is specified that the test piece consists of a metal. This has turned out to be well-suited, since metals are robust and, in addition, the workpieces to be washed have also, as a rule, been manufactured from a metal.

According to a particularly preferred example embodiment of the invention, it is specified that the test piece consists of aluminium. Since the gearshift devices to be washed also consist, as a rule, of aluminium, this consequently results in the greatest possible concordance between the test piece and the gearshift device in almost all properties.

According to another preferred example embodiment of the invention, it is specified that the test piece includes a plurality of side elements, each with at least one plane surface. Accordingly, the test piece consequently includes not just of two side elements but of several, permitting a simulation also of more complex workpieces. In this case, the side elements, like the first and the second side element, all exhibit bores and can be connected to one another, so that the bores of, invariably, two side elements are arranged in axial extension relative to one another in a manner analogous to the first bores and the second bores.

According to a particularly preferred example embodiment of the invention, it is specified that a foil has been inserted between each two mutually abutting plane surfaces. Since the other side elements also exhibit plane surfaces with bores, which abut one another in the connected state of the side elements, here too a foil can be inserted. Consequently, the washing performance can be tested on all possible sides of the test piece and at all possible places thereon.

### BRIEF DESCRIPTION OF THE DRAWINGS

In the following, example aspects of the invention will be elucidated in exemplary manner with reference to example embodiments represented in the Figures.

FIG. 1 shows, in exemplary manner, an embodiment of a test piece according to example aspects of the invention for testing a washing performance of an industrial washing machine,

FIG. 2 shows, in exemplary manner, the first side element and also the foil of the test piece from FIG. 1 after a washing process,

FIG. 3 shows, in exemplary manner, a further embodiment of a test piece according to example aspects of the invention for testing a washing performance of an industrial washing machine, and

FIG. 4 shows the test piece from FIG. 3 in a state in which all three side elements are connected to one another.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

Similar subject-matters, functional units and comparable components have been denoted by the same reference symbols across all the Figures. These subject-matters, functional units and comparable components have been realised identically as regards their technical features, unless explicitly or implicitly stated otherwise in the description.

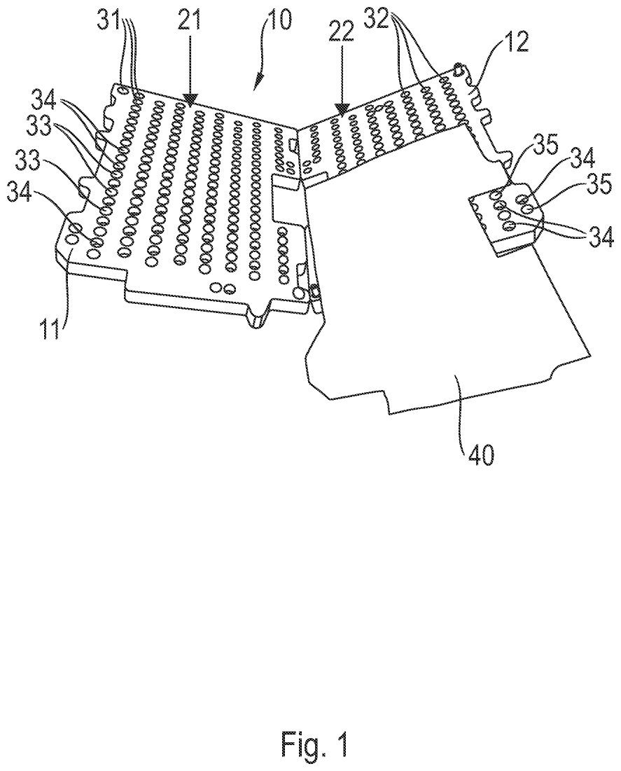

FIG. 1 shows, in exemplary manner, a embodiment of a test piece 10 according to example aspects of the invention for testing a washing performance of an industrial washing machine (not represented in FIG. 1). The test piece 10 consists, in accordance with the example, of aluminium and includes a first side element 11 and also a second side element 12, which in FIG. 1 are not connected to one another but have been arranged loosely side by side. As can be seen, both the first side element 11 and the second side element 12 exhibit a plane surface 21, 22, respectively. The first side element 11 is capable of being connected to the second side element 12 in such a manner that in the connected state of the side elements 11 and 12 the first plane surface 21 abuts or faces the second plane surface 22. As can further be seen, the first plane surface 21 exhibits first bores 31. In exactly the same way, the second plane surface 22 exhibits second bores 32. The first bores 31 alternately take the form of first through-bores 33 and of first blind bores 34. Similarly, the second bores alternately take the form of second through-bores 35 and of second blind bores 36. In a state where the first side element 11 is connected to the second side element 12, the first blind bores 34 are arranged in axial extension of the second through-bores 35 and, conversely, in the connected state the second blind bores 36 are arranged in axial extension of the first through-bores 33. Furthermore, a plastically deformable foil 40 made of aluminium can be seen, which can be inserted between the first plane surface 21 and the second plane surface 22.

The external geometry of the test piece 10 corresponds, according to the illustrated example embodiment, to a hydraulic gearshift device of a gear mechanism, for the cleaning of which the industrial washing machine to be tested has been provided. Inasmuch as the external geometry of the test piece 10 corresponds to the external geometry of the gearshift device, the test piece 10 can be channelled into the washing machine like a gearshift device and, where appropriate, even together with several of the gearshift devices, and can be subjected there to a washing process. During the washing process, the test piece 10 is blasted with water under high pressure; in particular, the water pressure is conducted selectively into the first and second through-bores 33, 35, so that the water pressure also pressurises the foil 40 within the first and second through-bores 33, 35 and can bring about a plastic deformation, according to the water pressure, of the foil 40 there in the region of the respective through-bore 33, 35.

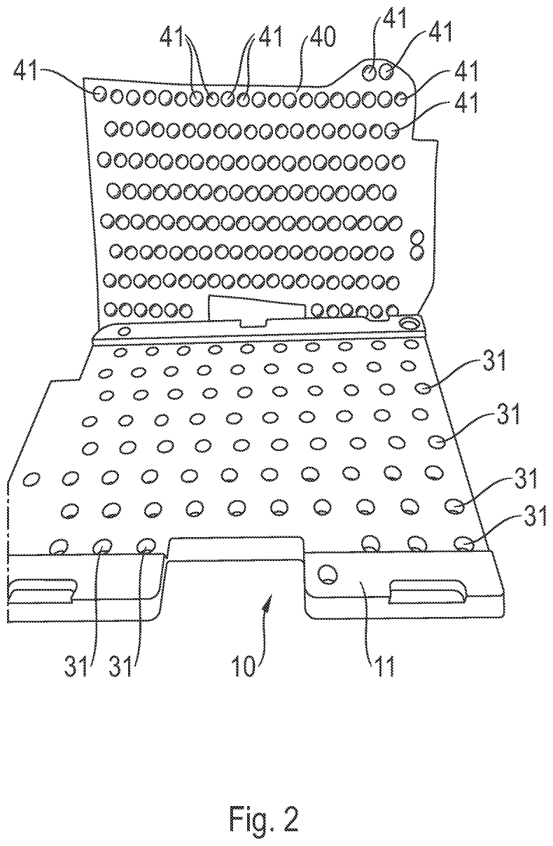

FIG. 2 shows, in exemplary manner, the first side element 11 and also the foil 40 of the test piece 10 from FIG. 1 after a washing process. As can be seen in FIG. 2, the foil 40 exhibits a series of plastic deformations 41, each of which is a measure of the water pressure and consequently of the washing performance to which the foil 40 has been subjected at the place in question. As can further be seen, the plastic deformations 41 of the foil 40 point alternately in a direction out of FIG. 2 and in a direction into FIG. 2, this having been caused by the fact that the first blind bores 34 are arranged in axial extension of the second through-bores 35, and conversely, and that the blind bores 34, 36 are in each instance arranged alternately with through-bores 33, 35 in the first and second surfaces 21, 22, respectively.

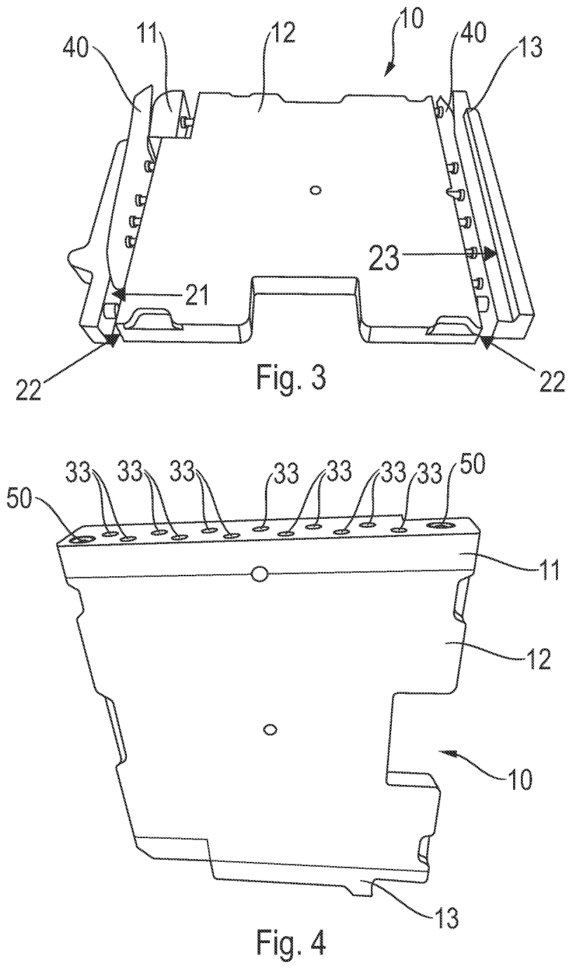

FIG. 3 shows, in exemplary manner, a further possible embodiment of a test piece 10 according to example aspects of the invention for testing a washing performance of an industrial washing machine (not represented in FIG. 3). As can be seen, the test piece 10 shown in FIG. 3 includes of a first side element 11, a second side element 12 and a third side element 13. The first side element 11 and the third side element 13 can each be arranged on the second side element 12, so that the first plane surface 21 of the first side element 11 abuts or faces a second plane surface 22 of the second side element 12, and similarly a third plane surface 23 of the third side element 13 abuts or faces a further second plane surface 22 of the second side element 12. A foil 40 can be inserted in each instance between the first plane surface 21 and the second plane surface 22 and also between the third plane surface 23 and the further second plane surface 22.

FIG. 4 shows the test piece 10 from FIG. 3 in a state in which all three side elements 11, 12, 13 are connected to one another. To be seen, furthermore, are the first through-bores 33 in the first side element and also two fastening bores 50 via which the first side element 11 can be connected to the second side element 12 by screws.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SYMBOLS

10 test piece
11 first side element
12 second side element
13 third side element
21 first plane surface
22 second plane surface
23 third plane surface
31 first bore
32 second bore
33 first through-bore
34 first blind bore
35 second through-bore
36 second blind bore
40 foil
41 plastic deformation
50 fastening bore

1-11: (canceled)

12. A test piece (10) for testing a washing performance of an industrial washing machine, comprising:
a first side element (11) with at least one first plane surface (21) that comprises first bores (31);
a second side element (12) with at least one second plane surface (22) that comprises second bores (32); and
a plastically deformable foil (40),
wherein the first side element (11) is connectable to the second side element (12) such that the first plane surface (21) faces the second plane surface (22), and
wherein, when the first side element (11) is connected to the second side element (12), the first bores (31) are arranged in axial extension of the second bores (32) and the plastically deformable foil (40) is disposed between the first plane surface (21) and the second plane surface (22).

13. The test piece (10) of claim 12, wherein the foil (40) is a metallic foil (40).

14. The test piece (10) of claim 13, wherein the foil (40) is an aluminium foil (40).

15. The test piece (10) of claim 12, wherein the first bores (31) comprise both first through-bores (33) and first blind bores (34), and the second bores (32) comprise both second through-bores (35) and second blind bores (36).

16. The test piece (10) of claim 15, wherein, when the first side element (11) is connected to the second side element (12), the first blind bores (34) are arranged in axial extension of the second through-bores (35) and the second blind bores (36) are arranged in axial extension of the first through-bores (33).

17. The test piece (10) of claim 12, wherein an external geometry of the test piece (10) corresponds identically to an external geometry of a workpiece to be washed by the washing machine.

18. The test piece (10) of claim 17, wherein the test piece (10) simulates a hydraulic gearshift device of a vehicle gear mechanism.

19. The test piece (10) of claim 12, wherein the test piece (10) consists of a metal.

20. The test piece (10) of claim 19, wherein the test piece (10) consists of aluminum.

21. The test piece (10) of claim 12, wherein the test piece (10) comprises at least one additional side element (13) with at least one respective plane surface (23).

22. The test piece (10) of claim 21, wherein a respective additional foil (40) is inserted between each two mutually abutting plane surfaces (21, 22, 23).
